(19) United States
(12) Patent Application Publication
(10) Pub. No.: US 2026/0200266 A1
(43) Pub. Date: Jul. 16, 2026

(54) WHEEL HUB

(71) Applicant: AKTIEBOLAGET SKF, GOTEBORG (SE)

(72) Inventors: Sebastian KRAUS, Schwanfeld (DE); Michael WENDEL, Bremen (DE)

(21) Appl. No.: 19/443,222

(22) Filed: Jan. 8, 2026

(30) Foreign Application Priority Data
Jan. 16, 2025 (DE) 102025101413.2

(51) Int. Cl. B60B 27/00

(52) U.S. Cl. CPC B60B 27/0094; B60B 27/0073; B60B 2310/54; B60B 2900/1212

(57) ABSTRACT

A wheel hub configured as a bearing inner ring for an anti-friction bearing includes a central axis of rotation and a body portion having a circular cross section perpendicular to the central axis of rotation. The body portion has a radial outer side and at least one functional surface on the radially outer side, the at least one functional surface including at least one raceway. At least a first functional surface of the at least one functional surface is laser-hardened. Also a related method.

### CROSS-REFERENCE

This application claims priority to German patent application no. 10 2025 101 413.2 filed on January 16, 2025, the contents of which are fully incorporated herein by reference.

### TECHNOLOGICAL FIELD

The present disclosure relates to a wheel hub having hardened surface portions.

### BACKGROUND

The functional surfaces of wheel hubs, for example the raceway surfaces, sliding surfaces or seal seats, have to be able to withstand the loads occurring there and are therefore hardened. An induction hardening method or a conventional method such as, for example, martensitic and/or bainitic hardening are usually used to this end. Although this leads to an inexpensive process, individual regions cannot be hardened in this manner, but rather only the surfaces in their entirety can be hardened.

Conventional heat treatments, such as martensitic hardening, bainitic hardening, case hardening, nitriding or induction hardening have disadvantages including:

batch processes (apart from induction hardening) without single piece flow;

great distortion leads to great oversize for the soft component and expensive reworking;

great expenditure for parts handling and logistics;

surface damage requires hard machining, in order to remove damaged surfaces (for example, decarburization, oxidation, etc.);

special part-related tooling costs and associated costs (for example, inductors for the induction hardening);

long changeover times when changing production parts;

selective hardening not possible (exception: induction hardening);

need for floor area for heat treatment plants.

### SUMMARY

It is therefore an aspect of the present disclosure to provide a wheel hub which can be produced inexpensively and in which individual regions of the functional surfaces can be hardened in a targeted manner.

The wheel hub is configured as a bearing inner ring for an anti-friction bearing (a rolling element bearing) and has, on the outer side, at least one raceway for rolling bodies of the anti-friction bearing.

In contrast to previous wheel hubs, in which the functional surfaces are induction-hardened, at least one functional surface of the wheel hub provided herein is laser-hardened. In this context, a functional surface of the wheel hub is understood to mean, for example, the raceway or raceway surface, a sliding surface or seal seat. A selected region, that is to say one or more functional surfaces, can be selectively hardened by the laser hardening in comparison with induction hardening, in which the entire region behind the flange of the wheel hub is usually induction-hardened. In particular, the at least one functional surface is hardened without a soft seam within the hardened region.

As a result of the use of a laser heat treatment for hardening this at least one functional surface, the at least one functional surface can be heated and therefore hardened in a very targeted manner. Furthermore, the process of laser-hardening does not require reworking and can be carried out as a last manufacturing step in a single work operation or in combination with soft machining, for example in a turning machine. Moreover, the abovementioned disadvantages are overcome by the use of laser-hardening.

In the case of laser-hardening, the steel components are heat-treated locally in such a way that a martensitic structure is produced by rapid laser heating and subsequent cooling by, above all, heat conduction. If necessary for geometric reasons and/or on account of the limited hardenability of the steel which is used, additional quenching media can be used (for example, compressed air or water), in order to increase the quenching speed.

Laser-hardening is distinguished by a limited energy/heat input and therefore low energy consumption and associated low CO₂ emissions, low distortion and limited or no surface oxidation. This offers the possibility of skipping subsequent hard machining steps for removing surface damage such as, for example, oxide layers/decarburized surfaces/scale which would occur in conventional hardening methods, and of integrating the hardening process into the soft machining. As a result, the throughput time and the handling and logistics expenditure in the manufacturing chain can be lowered.

Furthermore, laser hardening is distinguished by a high energy density and a short process time. It is likewise advantageous that only a small volume is affected, or only a small part of the workpiece cross section is treated, and that no process gases are required. As has already been mentioned above, active, external quenching of the workpiece after heating can additionally be dispensed with in the case of laser hardening, since the quenching takes place, above all, by heat conduction in the component. This has the advantages is that no quenching medium and therefore also no large pumps are required for quenching or cooling the plant. Furthermore, the same laser source and optics system can be used for different workpiece geometries, with the result that part-specific tool fitting can be dispensed with.

It is a further advantage of laser hardening that, in the case of laser hardening, only an extremely small distortion or even no distortion occurs on the bearing component, with the result that expensive reworking, in particular complex hard machining, can be dispensed with in part or completely. This additionally has the advantage that less material allowance is required, since a lower amount of deformation occurs, which means improved material utilization and likewise saves costs and energy/CO2.

Moreover, the laser-hardening process can be integrated into the soft machining sequence (for example, turning, milling, etc.), that is to say into the machining before the actual hardening and/or the hard machining process (for example, grinding, honing), that is to say the machining after the hardening, wherein even an integration into existing machines is possible. Moreover, an integration of a flexible laser-hardening unit can additionally take place into the soft machining, but also into the hard machining unit, which can reduce the cycle time and can increase the productivity to a high degree.

The remaining top surfaces of the wheel hub, apart from the at least one functional surface, remain untouched by the laser heat treatment and have the starting hardness of the soft component (for example, 20-40 HRC). Typical steel grades are all hardenable steel grades with the following exemplary chemical composition: carbon (0.40-1.10% by weight), silicon (0.15-0.35% by weight), manganese (0.60-1.10% by weight), chromium (0.30-2.00% by weight) and molybdenum (0.10-0.75% by weight).

The laser-hardening process of the functional surface/surfaces leads to a low hardness depth (up to at most 2 mm), in order to produce a hard and wear-resistant volume on the functional top surfaces. As a result of the laser-hardening process, the wear-resistance for avoiding excessive wear and the strength for avoiding excessive plastic deformation are increased.

As has already been explained above, the hardness depth of the at least one functional, laser-hardened surface can reach as far as at most 2 mm, in particular as far as at most 1.5 mm. Here, the hardness depth is to be understood to mean the region in which a phase transformation of the starting material from a ferritic basic structure into a martensitic structure takes place on account of the heat input by the laser. In other words, during the laser hardening of the at least one functional surface, a transformed boundary layer arises which extends over the hardness depth and is joined by the non-transformed basic structure.

Here, the hardness of the at least one functional, laser-hardened surface can be greater than 45 HRC, in particular greater than 50 HRC. As has already been explained above, this hardness is sufficient to protect the at least one functional surface against wear.

In accordance with a further embodiment, the top surface of the at least one functional, laser-hardened surface has a texture. The texture can be configured, for example, to increase the coefficient of friction of the surface. Furthermore, the texture can form lubricating grooves and/or a lubricant reservoir.

As mentioned above, a micro-structural phase change takes place during laser hardening, which leads to a change in the specific volume and/or to a change in the density of the physical phases, for example during the transformation into martensite and/or bainite. The hardened and transformed regions have a greater volume than in the initial phase, and this lead to an elevation of the laser-hardened top surfaces in the micrometre range.

Here, top surface regions which have been hardened to a “greater depth” rise to a greater height than top surface regions which have been hardened to a lesser “depth” or which have not been hardened at all. As a result, a defined top surface texture and topology can be applied to the functional surface. Here, as many top surface regions with different hardness depths as desired can be provided, in order to further refine the top surface texture, for example.

As an alternative, the texture can also arise as a result of partial melting of the top surface (crater formation) or else as a result of internal residual stresses which can be caused by the top surface heat treatment.

As has already been explained above, the regions which are hardened to different extents can thus be arranged in such a way that one region is configured as a lubricant reservoir and/or a lubricant groove which is delimited by another region. This advantageously contributes to a reduction of wear in the case of sliding contacts. Moreover, this can ensure that lubricant can be held at certain locations on the wheel hub and/or can be guided to certain locations.

For example, a “golf ball topography” (a dimpled surface) can thus be produced, in order to create lubricating pockets and, as a result, to improve the lubricating conditions. This can be achieved as mentioned above, either by selective hardening of local regions or by a different hardness depth. The depressions (dimples) which are produced act as lubricant reservoirs.

This behaviour or this property can also be utilized to produce textures for increased friction on the functional surfaces, in particular functional contact surfaces, in order, for example, to avoid a relative movement (for example, creeping) between the wheel hub and contact partners (housing/shaft). As a result of a positively locking connection or a frictionally locking connection with a very high coefficient of friction which impedes the relative movement of the wheel hub and the counterpart in the application, a weaker press fit/a lower contribution of the non-positive connection can be achieved, which in turn leads to lower tensile stresses in the wheel hub (for example, wheel hub shrink-fitted onto a shaft) and a longer component service life.

Therefore, one exemplary embodiment is also advantageous, in which the at least one functional surface has a first top surface region which is laser-hardened to a first hardness depth and has a first friction coefficient, and a second and/or third top surface region which are/is hardened to a second lesser hardness depth and have/has a second and third friction coefficient, respectively, wherein the first friction coefficient is higher than the second and/or third friction coefficient.

As a result of the targeted increase in the coefficient of friction of the wheel hub at defined locations, the relative movement between the wheel hub and a counterpart (for example, a shaft or a rim or a wheel) can be made more difficult in the application. The increase in the friction coefficient and also the special configuration of the top surface texture can enable a weaker press fit and/or a lower contribution of the non-positive connection, which in turn leads to lower tensile stresses in the wheel hub and a longer service life.

In accordance with a further embodiment, the laser-hardened region of the at least one functional surface is of continuous configuration.

This can achieve a situation where the functional surface is configured on the entire circumferential surface without a soft point or seam (as has already been mentioned above), which ensures, for example, a homogeneous friction coefficient increase and therefore a homogeneous force transmission. This can be achieved by way of one or more laser heads.

As an alternative, it can of course also be advantageous if the laser-hardened region of the at least one functional surface is configured as discrete top surface region portions.

A soft, non-laser-hardened region can thus be provided, for example, on the full circumferential surface between the start and end position of a scanning operation, or even a plurality of soft regions can be enabled, which configures defined patterns. Thus, for example, the hardening can be configured as a plurality of rectangles/squares, a plurality of circular/oval points, a plurality of triangles, or else as zigzag shapes, optionally with different angles.

Here, the patterns can contain further functions such as, for example, the abovementioned lubricant reservoirs or grooves. They can also be configured, however, merely as specific designs which, for example, already associate the wheel hub visually with the applicant as manufacturer.

In accordance with a further embodiment, the laser-hardened region has at least one soft point or soft seam, wherein the soft point/soft seam is arranged in a non-loaded region of the laser-hardened region, and/or wherein the soft point/soft seam is arranged at an angle with respect to a loading direction. There can be one soft point/soft seam or a plurality of soft points/soft seams.

A soft point/soft seam of this type can also arise, for example, by virtue of the fact that a region which has already been hardened is heated again. This can be brought about, for example, by the laser, which senses the surface to be hardened, again sweeping over regions of the surface to be hardened which have already been heated and cooled again.

As a result, the hardening method can be simplified considerably, since complex plant engineering or process control, in particular also for preheating, or the like, which would be necessary for hardening without slippage, that is to say hardening without any soft point or soft seam, can be dispensed with.

In principle, the functional surface can be hardened by means of laser hardening with a soft seam or without a soft seam, wherein the hardening without a soft seam is preferred.

The soft point or soft seam is preferably oriented in the axial direction or perpendicularly with respect to the loading direction.

In order to achieve an improved load and stress distribution, in accordance with a further embodiment the soft seam can be configured at a different angle than parallel to the axial direction of the wheel hub.

In accordance with a further embodiment, the wheel hub has a soft zone in a manner which adjoins the at least one functional, laser-hardened surface. As used herein, the term “soft zone” refers to a non-hardened (never hardened) zone between two laser-hardened functional surfaces and/or to a previously laser-hardened region that is reheated and cooled and thus tempered. This may occur by virtue of the fact that the laser which senses the surface to be hardened again sweeps over regions of a hardened region which have already been heated and cooled again.

A soft zone of this type has the following advantages:

lower energy usage (CO2) by avoiding hardening irrelevant regions (which do not require increased strength);

the original toughness remains unchanged, with the result that shock loads can be absorbed (no brittle martensite);

no mutual influencing of the heat treatments of hardened regions on both sides of the soft zone (influence of heat).

A soft zone can be either a greatly tempered surface (as described above, which arises, for example, as a result of the laser sweeping over a surface which has already been hardened) or a non-hardened surface. In both cases, this zone or this region is soft, wherein, in one case, the hard martensite is greatly tempered (in particular, hardened and greatly tempered) and, in the other case, the structure is not transformed. This means that a soft zone in the form of a non-hardened surface which therefore likewise affords the abovementioned advantages of a soft zone as a result of great tempering can also be provided in a manner which adjoins the at least one laser-hardened functional surface.

In particular, a plurality of functional surfaces can be laser-hardened, and non-hardened surfaces and/or soft zones can be provided between them. It can be ensured in this way that the hardening of a laser-hardened surface does not influence any other laser-hardened surface. The non-hardened surfaces or soft zones can therefore serve as buffer zones between the laser-hardened surfaces.

Further advantages and advantageous embodiments are specified in the description, the drawings and the claims. Here, in particular, the combinations of features which are specified in the description and in the drawings are purely by way of example, with the result that the features can also be present individually or combined in another way.

### BRIEF DESCRIPTION OF THE DRAWINGS

In the following text, the disclosure is to be described in greater detail on the basis of exemplary embodiments which are shown in the drawings. Here, the exemplary embodiments and the combinations shown in the exemplary embodiments are purely by way of example and are not intended to establish the scope of protection of the disclosure. This is defined solely by the appended claims.

FIG. 1 is a sectional view of a wheel hub according to an embodiment of the present disclosure.

FIG. 2 is a sectional view of a detail of the wheel hub of FIG. 1.

### DETAILED DESCRIPTION

In the following text, identical or functionally identical acting elements are identified using the same reference signs.

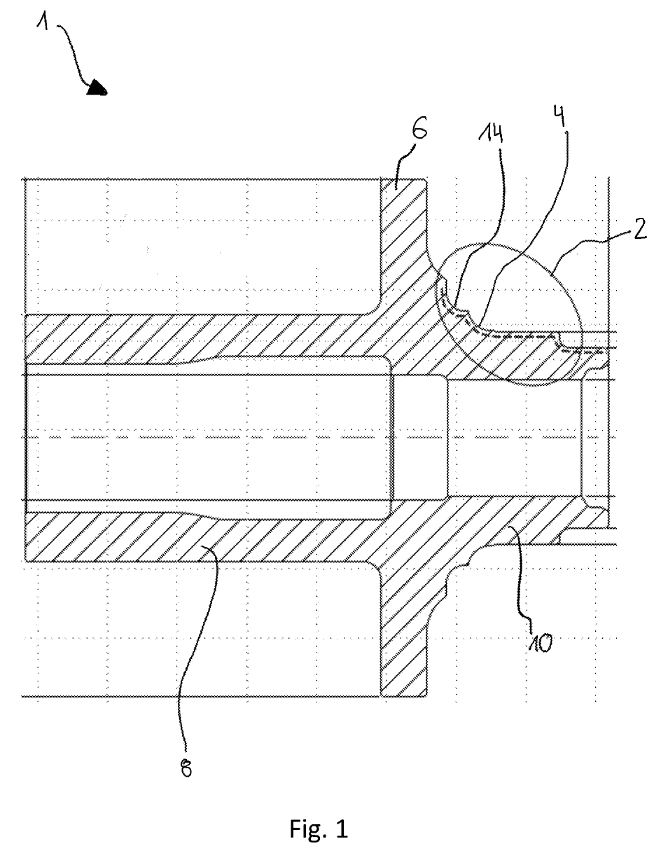

FIG. 1 shows a wheel hub 1 which is configured as a bearing inner ring for an anti-friction bearing (not shown). To this end, the wheel hub 1 has different surfaces 2 for the anti-friction bearing. These include, inter alia, a raceway 4 for rolling bodies of the anti-friction bearing and a seal seat 14, on which a seal for sealing the anti-friction bearing can be arranged. The surfaces 2 are also called functional surfaces here.

The raceway 4 is arranged on a cylindrical portion 10 of the wheel hub. This portion 10 is separated by a flange 6 from a further portion 8 which can have one or more non-functional surfaces.

Up to now, the functional surfaces such as, for example, the raceway 4 have been hardened by an induction-hardening process. Here, however, only the entire region of the surfaces 2 could be hardened, that is to say all the surfaces on the right-hand side of the flange 6. Targeted hardening of individual regions is not necessary here.

Therefore, at least one functional surface of the wheel hub 1 which is shown here is hardened by means of a laser-hardening process. This has the advantage, inter alia, that selective regions of the functional surfaces 2 can be hardened in a targeted manner, without any thermal influencing of other regions which have already previously been hardened.

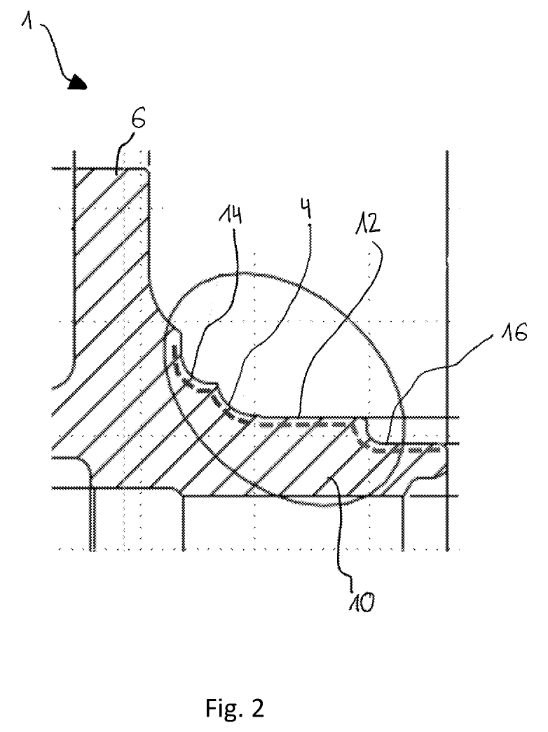

In the following text, the wheel hub will be described in greater detail with reference to FIG. 2. As has already been mentioned, selective regions of the functional surfaces 2 can be hardened by the use of a laser-hardening process. These functional surfaces 2 include the raceway 4, the seal seat 14, but also further functional surfaces 12, 16.

The further functional surfaces 12, 16 can be, for example, press fits, onto which parts can be shrink-fitted and which can be subjected, above all, to top surface wear here. If these surfaces are hardened, this top surface wear can be reduced. Furthermore, an increase in the coefficient of friction (for example, as a result of structures/textures in the hardened surface) can be advantageous here, in order to reduce the overlap/stresses when being pressed on. The surface 12 can also be non-hardened.

As has already been explained above, highly precise hardening of different selected functional surfaces 2 is possible by way of the laser-hardening process. The abovementioned surfaces 4, 12, 14, 16 can be hardened in a targeted manner here, wherein soft zones or non-hardened regions (not shown) can be present between these surfaces 4, 12, 14, 16. In contrast to the previously used induction-hardening process, in which all the functional surfaces 2 in their entirety were hardened, the individual functional surfaces 2, 12, 14, 15 can therefore be laser-hardened selectively here with regions (as a soft zone or simply as non-hardened regions) arranged in between. This selective, targeted hardening has the advantage that only the regions which are actually intended to be hardened are hardened. They can therefore also preferably be hardened without a soft zone or a soft seam.

In summary, a wheel hub is provided here which, on account of the laser-hardened functional surfaces, has a longer service life and less expensive production (on account of the reworking not being required) in comparison with previous wheel hubs.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved wheel hubs.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A wheel hub configured as a bearing inner ring for an anti-friction bearing, the wheel hub comprising:
a central axis of rotation,
a body portion having a circular cross section perpendicular to the central axis of rotation and having a radial outer side, and
at least one functional surface on the radially outer side, the at least one functional surface including at least one raceway,
wherein at least a first functional surface of the at least one functional surface is laser-hardened.

2. The wheel hub according to claim 1,
wherein the first functional surface of the at least one functional surface is a first raceway of the at least one the raceway.

3. The wheel hub according to claim 2,
wherein a second functional surface of the at least one functional surface is a seal seat.

4. The wheel hub according to claim 2,
including a soft zone adjoining the first functional surface.

5. The wheel hub according to claim 1,
wherein the at least a first functional surface of the at least one functional surface comprises a first functional surface and a second functional surface separated by a soft zone.

6. The wheel hub according to claim 5,
wherein a hardness depth of first functional surface of the at least one functional surface is less than or equal to 2 mm.

7. The wheel hub according to claim 1,
wherein a hardness depth of first functional surface of the at least one functional surface is less than or equal to 1.5 mm.

8. The wheel hub according to claim 7,
wherein a hardness of the first functional surface of the at least one functional surface is greater than 45 HRC.

9. The wheel hub according to claim 9
wherein a hardness of the first functional surface of the at least one functional surface is greater than 50 HRC.

10. A method comprising:
providing a wheel hub configured as a bearing inner ring for an anti-friction bearing, the wheel hub including a central axis of rotation, a body portion having a circular cross section perpendicular to the central axis of rotation and having a radial outer side, and at least one functional surface on the radially outer side, the at least one functional surface including at least one raceway, and
laser hardening at least a first functional surface of the at least one functional surface.

11. The method according to claim 10,
wherein the first functional surface of the at least one functional surface is a first raceway of the at least one the raceway.

12. The method according to claim 11,
wherein a second functional surface of the at least one functional surface is a seal seat.

13. The method according to claim 11,
wherein the at least a first functional surface of the at least one functional surface comprises a first functional surface and a second functional surface separated by a soft zone.

14. The method according to claim 11,
wherein the laser hardening comprises laser hardening to a depth of less than or equal to 2 mm.

15. The method according to claim 11,
wherein the laser hardening comprises laser hardening to a depth of less than or equal to 1.5 mm.

16. The method according to claim 11,
wherein the laser hardening comprises laser hardening to a hardness of greater than 45 HRC.

17. The method according to claim 11,
wherein the laser hardening comprises laser hardening to a hardness of greater than 50 HRC.
